(19) United States
(12) Patent Application Publication
(10) Pub. No.: US 2025/0356665 A1
(43) Pub. Date: Nov. 20, 2025

(54) SYSTEM AND METHOD FOR DETECTING AND IDENTIFYING CONTAINER NUMBER IN REAL-TIME

(71) Applicant: ATAI LABS PRIVATE LIMITED, Banjara Hills, Hyderabad (IN)

(72) Inventors: KRISHNA KISHORE ANDHAVARAPU, Hyderabad (IN); LOVARAJU ALLU, Visakhapatnam (IN); SRIKAR REDDY VUNDI, Hyderabad (IN); NAGALAKSHMI GUDALA, Tanuku (IN); SATISH CHANDRA GUNDA, Kurnool (IN); KISHOR ARUMILLI, Hyderabad (IN); GANGADHAR GUDE, Hyderabad (IN)

(21) Appl. No.: 18/867,083

(22) PCT Filed: Apr. 14, 2023
(86) PCT No.: PCT/IB2023/053837

§ 371 Date: Nov. 19, 2024

(30) Foreign Application Priority Data
Apr. 20, 2022 (IN) 202241023158

(51) Int. Cl. G06V 20/62; G06V 10/25; G06V 10/26; G06V 10/36; G06V 10/74; G06V 10/762; G06V 10/764; G06V 10/82; G06V 20/52; G06V 30/148; G06V 30/19; G06V 30/20; H04N 7/18

(52) U.S. Cl. CPC G06V 20/62; G06V 10/25; G06V 10/26; G06V 10/36; G06V 10/761; G06V 10/762; G06V 10/764; G06V 10/82; G06V 20/52; G06V 30/15; G06V 30/153; G06V 30/19093; G06V 30/19107; G06V 30/19173; G06V 30/20; H04N 7/181; G06V 2201/08

(57) ABSTRACT

Exemplary embodiments of the present disclosure are directed towards a method for detecting and identifying container number in real-time. Monitoring vehicle carrying containers and triggering first camera, second camera, third camera, fourth camera, fifth camera, and laser sensors to capture container views by pre-processing module. Transmitting containers image data to computing device by the pre-processing module. Detecting container number region in container image frames by visual object detection module. Cropping container number region by visual object detection module. Applying two-dimensional Fast Fourier Transform on cropped container number region. Segmenting each character situated in container number region by segmentation and character classification module. Classifying each character situated in container number region by segmentation and character classification module. Arranging characters in order based on relative positions of characters to obtain container number information by segmentation and character classification module. Aggregating container image frames and generating container number by post-processing module.

### TECHNICAL FIELD

The disclosed subject matter relates generally to container number identification. More particularly, the present disclosure relates to a system and method for detecting and identifying container numbers when the container is being carried into or out of the container storage yard in real-time.

### BACKGROUND

A container number is a unique number in standard format to identify containers. The container number is printed on all sides of the container except the bottom one. The container number is an 11-character length string in standard format. The container number plays an important role in identifying and tracking the container during an import and export cycle. Today, in most of the container yards, the container number is captured manually by the surveyor and later fed into the systems. This process of manual intervention is inducing the errors into the system and also reducing the throughput.

Generally, the characters of the container number are arranged in multiple rows within a confined location. It is essential to arrange all the characters in order to predict the container number successfully. However, it is very challenging in real environments to perform this task as the images are captured at multiple angles, as the container passes and the arrangement is not strictly horizontal or vertical. Hence, there is a need to detect the container number automatically, which enables efficiency by increasing the throughput and accuracy by reducing the manual errors.

In the light of the aforementioned discussion, there exists a need for a certain system with novel methodologies that would overcome the above-mentioned disadvantages.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure directed towards a system and method for detecting and identifying container numbers when the container is being carried into or out of the container storage yard.

Another objective of the present disclosure directed towards a system that uses cameras and a laser sensor together to improve the accuracy of motion detection logic.

Another objective of the present disclosure directed towards a system that uses a multi-scale structural similarity index measure to obtain better motion detection performance using the cameras.

Another objective of the present disclosure directed towards a system that uses a neural network in association with motion detection to detect the start and end of a container in motion. This also helps to detect cases where the truck carrying a container halts for some time and proceeds.

Another objective of the present disclosure directed towards a system that uses the cameras in IR mode to get reliable results in low light conditions.

Another objective of the present disclosure directed towards a system that uses real-time information as the container passes through the cameras' field of view to discard detections from previous or next containers when they move in close proximity.

Another objective of the present disclosure directed towards a system that uses a two-dimensional Fast Fourier Transform to pre-process the images and reduce the effect of shadows.

Another objective of the present disclosure directed towards a system that uses a character segmentation technique to process both horizontal and vertical rows of characters.

Another objective of the present disclosure directed towards a system that uses a character segmentation technique to process characters of different colors against various background colors without any manual input.

Another objective of the present disclosure directed towards a system that discards unwanted segments using image segment properties like width, height, mean of pixels, and variance of pixels.

Another objective of the present disclosure directed towards a system that uses clustering techniques to group characters and to arrange the characters in order.

Another objective of the present disclosure directed towards a system that uses temporal information and detection results from a single camera to separate frames belonging to two different containers stacked on the same truck.

Another objective of the present disclosure directed towards a system that uses a laser sensor to detect separation between the containers and differentiate between two different containers stacked on the same truck.

In an embodiment of the present disclosure, a system comprising a motion detection unit configured to monitor a vehicle carrying containers into or out of the container storage yard.

In another embodiment of the present disclosure, the motion detection unit comprising the first camera, the second camera, the third camera, the fourth camera, the fifth camera, laser sensors.

In another embodiment of the present disclosure, the first camera, the second camera, the third camera, the fourth camera, the fifth camera, and the laser sensors configured to capture the containers views.

In another embodiment of the present disclosure, the pre-processing module configured to trigger the first camera, the second camera, the third camera, the fourth camera, the fifth camera, and the laser sensors to capture the container views.

In another embodiment of the present disclosure, the pre-processing module configured to transmit containers image data to the computing device through the processing device.

In another embodiment of the present disclosure, the computing device comprising the container number detection module configured to analyze the containers image data to identify the container number and displays the container number on the computing device.

In another embodiment of the present disclosure, the container number detection module comprising a visual object detection module configured to detect a container number region in container image frames.

In another embodiment of the present disclosure, the one or more container image frames are identified by the visual object detection module based on a field of view and orientation of the first camera, the second camera, the third camera, the fourth camera, and the fifth camera.

In another embodiment of the present disclosure, the visual object detection module configured to crop the container number region situated on the container image frames.

In another embodiment of the present disclosure, the visual object detection module configured to apply two-dimensional Fast Fourier Transform on the cropped container number region to reduce an impact of shadows on one or more container image frames.

In another embodiment of the present disclosure, a segmentation and character classification module configured to acquire the container number region as an output from the visual object detection module.

In another embodiment of the present disclosure, the segmentation and character classification module configured to segment each character situated in the container number region using computer vision techniques and classifies each character using a neural network technique.

In another embodiment of the present disclosure, the segmentation and character classification module configured to arrange the characters in an order based on relative positions of the characters to obtain the container number.

In another embodiment of the present disclosure, a post-processing module configured to generate the container number by aggregating the output from series of the one or more container image frames captured by the motion detection unit.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is an example diagram depicting a system for detecting and identifying container numbers, in accordance with one or more exemplary embodiments.

FIG. 2 is a block diagram depicting a schematic representation of the container number detection module 110 shown in FIG. 1, in accordance with one or more exemplary embodiments.

FIG. 3A, FIG. 3A is an example diagram depicting a schematic representation of the pre-processing module 204 shown in FIG. 1, in accordance with one or more exemplary embodiments.

FIG. 3B, FIG. 3C, FIG. 3D, FIG. 3E, FIG. 3F, are example diagrams depicting the first camera view, the second camera view, the third camera view, the fourth camera view and the fifth camera view, in accordance with one or more exemplary embodiments.

FIG. 4A, FIG. 4B are example diagrams depicting the horizontal arrangement and vertical arrangement of container number, in accordance with one or more exemplary embodiments.

FIG. 4C, FIG. 4D are example diagrams depicting the dark characters against light background and light characters against dark background, in accordance with one or more exemplary embodiments.

FIG. 4E is an example diagram depicting the container number arranged in multiple rows, in accordance with one or more exemplary embodiments.

FIG. 4F is an example diagram depicting the container separation logic when same truck carries two containers, in accordance with one or more exemplary embodiments.

FIG. 4G is an example diagram depicting the post-processing module, in accordance with one or more exemplary embodiments.

FIG. 4H is an example diagram depicting the container number generation module 416, in accordance with one or more exemplary embodiments.

FIG. 5A is an example diagram depicting the first camera view, in accordance with one or more exemplary embodiments.

FIG. 5B is an example diagram depicting the second camera view, in accordance with one or more exemplary embodiments.

FIG. 5C is an example diagram depicting the third camera view, in accordance with one or more exemplary embodiments.

FIG. 5D is an example diagram depicting the fourth camera view, in accordance with one or more exemplary embodiments.

FIG. 5E is an example diagram depicting the fifth camera view, in accordance with one or more exemplary embodiments.

FIG. 6 is an example diagram depicting the container carrying trucks pass the gate infrastructure in close proximity, in accordance with one or more exemplary embodiments.

FIG. 7 is example of flow diagram depicting a method for discarding the detections, in accordance with one or more exemplary embodiments.

Referring to FIG. 8 is an example diagram depicting the visual object detection, in accordance with one or more exemplary embodiments.

FIG. 9 is an example of flow diagram depicting a method of segmentation, in accordance with one or more exemplary embodiments.

FIG. 10 is a block diagram illustrating the details of digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

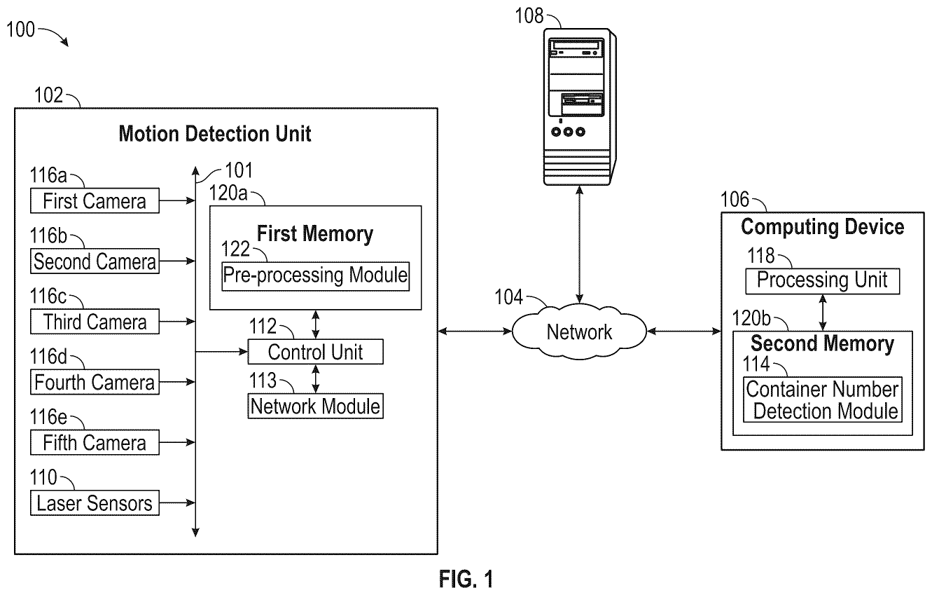

Referring to FIG. 1, FIG. 1 is an example diagram 100 depicting a system for detecting and identifying container numbers, in accordance with one or more exemplary embodiments. The system 100 includes a motion detection unit 102, a network 104, a computing device 106, and a server 108. The motion detection unit 102 may include a first camera 116a, a second camera 116b, a third camera 116c, a fourth camera 116d, a fifth camera 116e, laser sensors 110, a control unit 112, a network module 113 a first memory 120a and a pre-processing module 122. The laser sensors 110 may be configured to improve the accuracy of the motion detection of the vehicle. The control unit 112 may include, but not limited to, a microcontroller (for example ARM 7 or ARM 11), a raspberry pi, a microprocessor, a digital signal processor, a microcomputer, a field programmable gate array, a programmable logic device, a state machine or a logic circuitry.

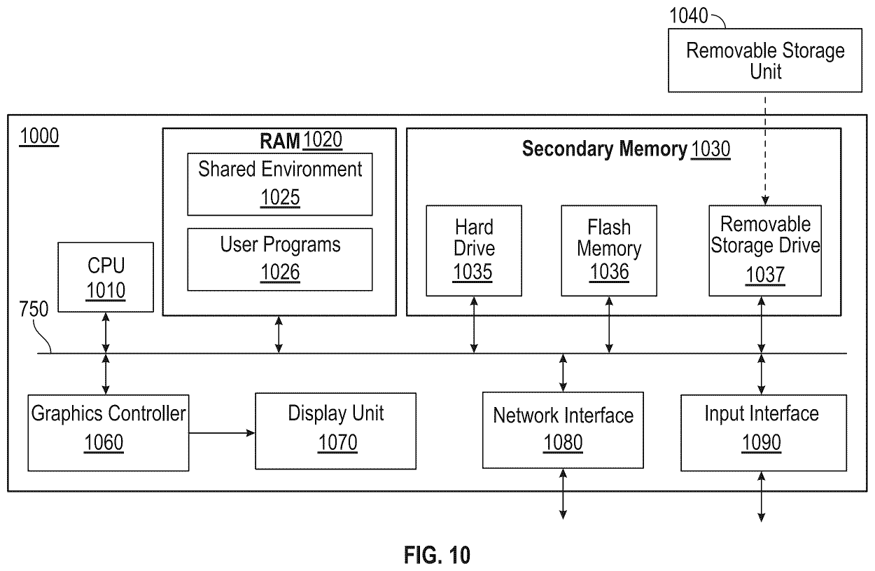

The computing device 106 includes a processing unit 118. The processing unit 118 may also be represented as CPU (as shown in FIG. 10). The processing unit 118 may execute instructions stored in a second memory 120b to provide several features of the present disclosure. The secondary memory may be The processing unit 118 may contain multiple processing units, with each processing unit potentially being designed for a specific task. Alternatively, the processing unit 118 may contain only a single general-purpose processing unit.

The computing device 106 includes a container number detection module 114 which is stored in the second memory 120b. The container number detection module 114 configured to detect and identify the container number when the container is being carried into or out of the container storage yard. The container number detection module 114 configured to detect and identify the container number along with the ISO code of the container. The container number may be represented in alphanumeric characters, numbers, alphabets, and so forth. The ISO code of the container is an international standard which describes the identification of the container. The standard is maintained by the BIC (International Container Bureau) and covers the serial number, owner, country code, and size of any given container. Typically, the containers are stacked on the vehicles and the vehicles pass through a gate like structure. The vehicles may include, but not limited to, trucks, carrying containers, wagon and so forth. The vehicle may also be represented as a truck in the following description.

The pre-processing module 122 may be configured to determine the motion of the truck and enables the motion detection unit 102 to capture the multiple container views. The container views may include, but not limited to, a front view, a rear view, a right view, a left view, and a top view. The motion detection unit 102 includes the first camera 116a may be a front camera configured to capture the front view of the containers, the second camera 116b may be a rear/back camera configured to capture the rear-view of the containers, the third camera 116c may be a right camera configured to capture the right view of the containers, the fourth camera 116d may be a left camera configured to capture the left view of the containers, the fifth camera 116e may be a top camera configured to capture the top view of the containers.

The first camera 116a, the second camera 116b, the third camera 116c, the fourth camera 116d, the fifth camera 116e may be three-dimensional cameras, thermal image cameras, infrared cameras, night vision cameras, varifocal cameras, and so forth. The first camera 116a, the second camera 116b, the third camera 116c, the fourth camera 116d, the fifth camera 116e may be operated in an infrared mode to obtain reliable results in a low light conditions thereby eliminating the use of an artificial light.

The first camera 116a, the second camera 116b, the third camera 116c, the fourth camera 116d, and the fifth camera 116e may be configured to deliver the containers image data to the computing device 106 over the network 104. The containers image data may include the front view images, the rear view images, the right-view images, the left-view images, and the top-view images. The containers are stacked on the vehicle and may be placed in two ways, one is the front side of the container facing the truck cabinet or rare side of the container facing the truck cabinet. The truck may carry a maximum number of two containers and in case of twin containers.

The first camera 116a, the second camera 116b, the third camera 116c, the fourth camera 116d, and the fifth camera 116e may be configured to capture infrared mode container images to obtain better results during low light conditions thereby eliminating the use of the artificial light. The container number detection module 114 may be configured to analyze the containers image data to detect and identify the container number being carried on the truck.

The motion detection may be performed on a fixed region of a container image frame using the computer vision techniques stored in the first memory 120a. The pre-processing module 122 may include a multi-scale structural similarity index technique configured to enhance the accuracy of motion detection logic and discard most of the false positives and false negatives.

The pre-processing module 122 may be configured to discard the possibility of detecting the container numbers from previous or next containers in the queue when the trucks passes in a close proximity. The pre-processing module 122 may be configured to enable the second camera 116b (rear camera) to detect the vehicle carrying container moving towards the end of motion detection and the first camera 116a (front camera) to detect the vehicle carrying container moving towards the start of the motion detection.

The pre-processing module 122 may be configured to perform concurrent and parallel processing to read the containers image data from the motion detection unit 102 covering multiple sides of the truck and feed the containers image data to the computing device 106 over the network 104. The network 104 may include, but is not limited to, an Ethernet, a wireless local area network (WLAN), or a wide area network (WAN), a Bluetooth low energy network, a ZigBee network, a Controller Area Network (CAN bus), a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

The pre-processing module 122 may be configured to trigger the motion detection unit 102 to capture the multiple container views once the container is in the field of view of the motion detection unit 102. This is achieved by performing motion detection from one of the side cameras (for example, third camera and the fourth camera).

The container number detection module 114 may include a structural similarity index measuring technique configured to enhance the accuracy of the motion detection logic and discard most of the false negatives. The container number detection module 114 includes a neural network in association with the motion detection to detect the start and end of the containers in motion. The neural network may also helps to detect whether the truck carrying the containers halts for some time and proceeds. The container number detection module 110 may be configured to identify and display the container numbers on the computing device 106.

Although the computing device 106 as shown in FIG. 1, an embodiment of the system 100 may support any number of computing devices. The system 100 may support only one computing device 106. The computing device 106 may include, but are not limited to, a desktop computer, a personal mobile computing device such as a tablet computer, a laptop computer, or a netbook computer, a smartphone, a server, an augmented reality device, a virtual reality device, a digital media player, a piece of home entertainment equipment, backend servers hosting database and other software, and the like. Each computing device 106 supported by the system 100 is realized as a computer-implemented or computer-based device having the hardware or firmware, software, and/or processing logic needed to carry out the intelligent messaging techniques and computer-implemented methodologies described in more detail herein.

The container number detection module 114 may be downloaded from the server 108. For example, the container number detection module 114 may be any suitable application downloaded from, GOOGLE PLAY® (for Google Android devices), Apple Inc.'s APP STORE® (for Apple devices, or any other suitable database). In some embodiments, the container number detection module 114 may be software, firmware, or hardware that is integrated into the computing device 106. The container number detection module 114 which is accessed as mobile applications, web applications, software that offers the functionality of accessing mobile applications, and viewing/processing of interactive pages, for example, are implemented in the computing device 106 as will be apparent to one skilled in the relevant arts by reading the disclosure provided herein.

The system 100 may be structured to detect and identify the container number and the properties of the container. The properties of the container may include, the presence of the container number on all the sides of the container as well as the fact that the containers move through a gate like structure. The placement and the orientation of the first camera 116a, the second camera 116b, the third camera 116c, the fourth camera 116d, and the fifth camera 116e may be configured to capture the container number along with the ISO code of the container. The ISO code of the container is an international standard which describes the identification of the container. The standard is maintained by the BIC (International Container Bureau) and covers the serial number, owner, country code, and size of any given container.

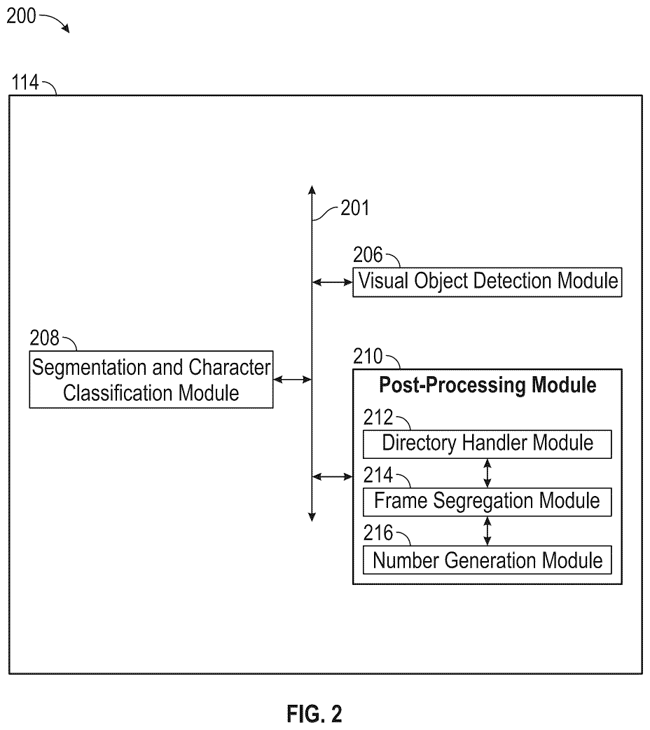

Referring to FIG. 2, FIG. 2 is a block diagram 200 depicting a schematic representation of the container number detection module 110 shown in FIG. 1, in accordance with one or more exemplary embodiments. The diagram 200 includes a bus 201, a visual object detection module 206, a segmentation and character classification module 208, and a post-processing module 210. The post-processing module 210 includes a directory handler module 212, a frame segregation module 214, and a number generation module 216. The bus 201 may include a path that permits communication among the modules of the data analyzation and precise decision module installed on the computing device 102. The term “module” is used broadly herein and refers generally to a program resident in the memory of the computing device 106.

The visual object detection module 206 may be configured to receive the containers image data from the pre-processing module 122 over the network 104. The visual object detection module 206 may be configured to detect a container number region in the entire container image frame based on the field of view and orientation of the first camera 116a, the second camera 116b, the third camera 116c, the fourth camera 116d, and the fifth camera 116e. The container number region may be situated on the front view images, the rear view images, the right view images, the left view images, and the top view images of the containers. The visual object detection module 206 may include a neural network techniques configured to detect the container number region where the container number is visible in the entire container image frame. Alternatively, the region where the container number is visible in the entire image frame may also be achieved using the computer vision techniques. The output of the visual object detection module 206 may be stored in a directory and is accessed by the segmentation and character classification module 208 for further processing. The detected container number region in the container image frame may be cropped after the visual object identification and the cropped container number image is used for recognizing the container number.

The visual object detection module 206 may use a two-dimensional Fast Fourier Transform and merge high and low-frequency components to reduce shadow effects. The visual object detection outputs localized bounding boxes to crop the container number region from the containers image data captured by the pre-processor module 122. These containers image data may be used by next stages to recognize the container number and ISO (International Organization for Standardization) code. However, the computing device 106 may receive the containers image data with varying illumination due to shadows during the day time. The visual object detection module 206 may be configured to extract high-frequency and low-frequency components of the containers image data using two-dimensional FFT and merge them back with higher weightage to high frequency component. The two-dimensional Fast Fourier Transform greatly reduces the impact of shadows on the containers image data.

The segmentation and character classification module 208 may be configured to receive the cropped container number image from the visual object detection module 206 and performs the segmentation in a two-stage approach. In the first stage, the segmentation and character classification module 208 may be configured to segment each character in the container number image using computer vision techniques. Classifying each character using a custom neural network technique. Arranging all the characters in the order based on their relative positions using multiple techniques, for example clustering and simple mathematical comparison operations.

The post-processing module 210 may be configured to generate the container number by aggregating the output from the series of the container image frames captured by the motion detection unit 102 corresponding to a particular motion (sequence number) detection cycle. The output from the classifier is placed in the class output folder. The output file details are as follows: The file name of the output file from the class output may be in the following format:

<sequence_id>_<camera_id>_<frame_id>.json\

sequence_id: The sequence id may be generated by the pre-processor module 122 for the truck when motion is detected, and the sequence id may be the same for all the image frames captured till the end of motion.

camera_id: one of [‘LT’,‘RT’,‘FT’,‘BK’,‘TP’] based on the location of the camera.

frame_id: Index of the captured frame. Resets to zero per side whenever a new vehicle motion is detected.

For example, the class output file name for the front camera frames is as follows:
1599186628_FR_1.json
1599186628_FR_2.json
1599186628_FR_3.json

For example, the class output file name for rear camera frames is as follows
1599186628_BK_1.json
1599186628_BK_2.json
1599186628_BK_3.json

The post-processing module 210 includes the directory handler module 212 may be configured to read the container image files placed in the class output directory and creates a truck instance per sequence_id. The truck instance may be configured to hold the list of the output data, one from each side. The truck instance may be configured to hold five lists (Front Cam, Rear Cam, Left Cam, Right Cam, and Top Cam). The output list segregation may be performed based on the camera_id represented in the file name. All the class output data containing the same camera_id may be added to the corresponding list. The output list may include the container frames of each side of the container, so in total it holds five lists (Front Cam, Rear Cam, Left Cam, Right Cam, and Top Cam).

The frame segregation module 214 may be configured to segregate the list based on the camera_id represented in the file name. The output data containing the same camera_id may be added to the corresponding list. A timer may be implemented per truck instance to trigger the process of generating container numbers from the above captured lists. The directory watcher watches the directories of the pipeline and may reset the timer of the truck instance when a new file with the same sequence_id is added in any of the directories in the pipeline. When no new file is added with the sequence_id for a specified period, then the timer thread may trigger the process of generating the container numbers from the output lists (Front, Rear, Left, Right, and Top).

In an exemplary embodiment, the trucks carrying two containers, the third camera 116c, the fourth camera 116d, and the fifth camera 116e may hold the container number data, which belongs to both the containers. The output list may be sorted by frame_id and further split into two lists such that each list may hold the data belonging to a single container. The output list splitting may be performed by thresholding the frame_id which is part of the file name. Once segregation is performed, the lists (FT, BK, LT, RT, TP) belonging to a single container may be merged into a single list.

In the first level of filtering, each element in the container data list is a json data with the container number in it. Because not all container frames output may generate the container number with 11 characters, list elements with the container numbers of less than 11 characters may be filtered out of the lists.

The 11th character in the container number is a check digit. At this stage, the list element which does not have a valid check digit may be removed from the list by the check digit filter. The container number with more occurrences (mode) in the list is the derived container number. After performing the check digit filter, if the length of the output list is empty (not a single item has a valid check digit), the output from the first level filter is used to derive the container number by performing mode operation for individual characters.

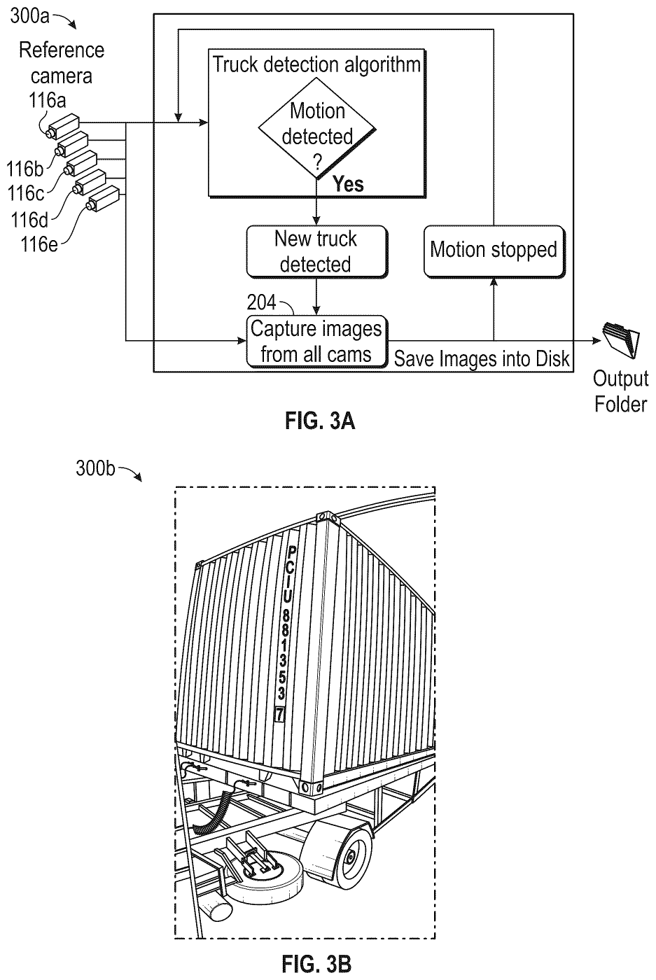

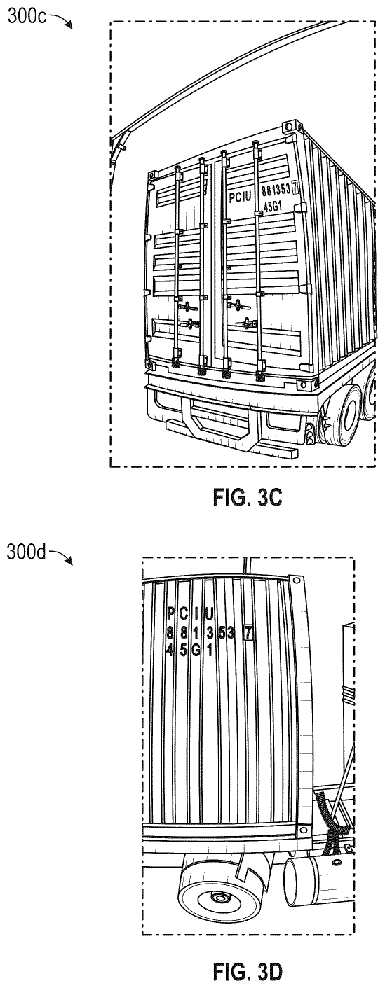

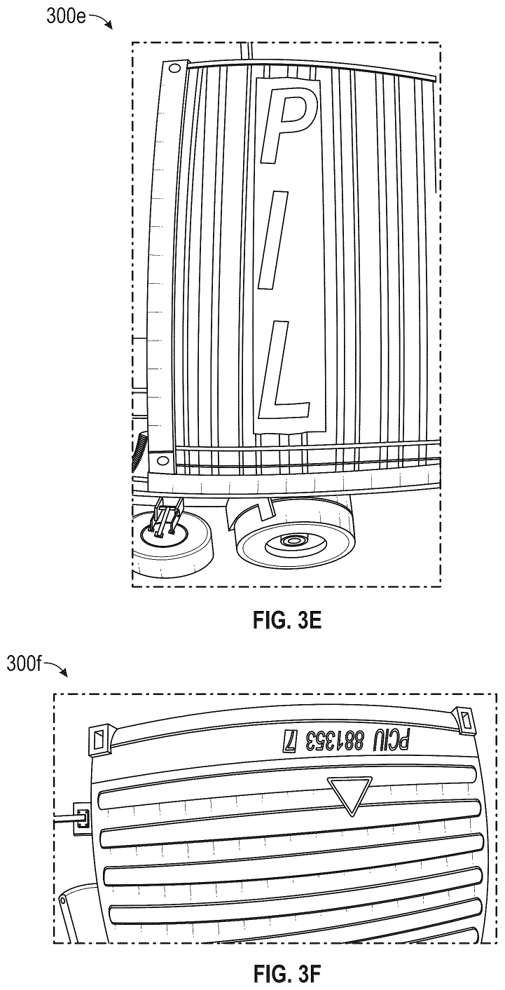

Referring to FIG. 3A, FIG. 3A is an example diagram 300a depicting a schematic representation of the pre-processing module 122 shown in FIG. 1, in accordance with one or more exemplary embodiments. The diagram 300a includes cameras 116a, 116b, 116c, 116d and 116e, the pre-processing module 122. The pre-processing module 122 may be configured to detect the motion of the truck and trigger the cameras 116a, 116b, 116c, 116d and 116e to capture the multiple container views. The motion detection may be performed on a fixed region of a container image frame by using computer vision techniques. The pre-processing module 122 may be configured to perform concurrent and parallel processing to read the container image data from multiple cameras 116a, 116b, 116c, 116d, and 116e covering all the sides of the truck (carrying containers) and feed the containers image data to the pipeline for the visual object detection module 206 and the segmentation and classification module 208. The containers image data captured from the cameras 116a, 116b, 116c, 116d, and 116e may be triggered once the container is in the field of view of the cameras 116a, 116b, 116c, 116d, and 116e. This is achieved by performing motion detection from one of the side cameras (the third camera 116c or the fourth camera 116d).

Referring to FIG. 3B, FIG. 3C, FIG. 3D, FIG. 3E, and FIG. 3F, are example diagrams 300b, 300c, 300d, 300e, and 300f depicting the first camera view, the second camera view, the third camera view, the fourth camera view, and the fifth camera view, in accordance with one or more exemplary embodiments. The diagram 300b depicts the first camera view 302 of the container captured by the first camera 116a. The first camera view 302 may include the front view image of the container. The diagram 300c includes the second camera view 304 of the container captured by the second camera 116b. The second camera view 304 may include the rear view image of the container. The diagram 300d includes the third camera view 306 of the container captured by the third camera 116c. The third camera view 306 may include the right side view image of the container. The diagram 300e includes the fourth camera view 308 of the container captured by the fourth camera 116d. The fourth camera view 308 may include the left side view image of the container. The diagram 300f includes the fifth camera view 310 of the container captured by the fifth camera 116e. The fifth camera view 310 may include the top view image of the container.

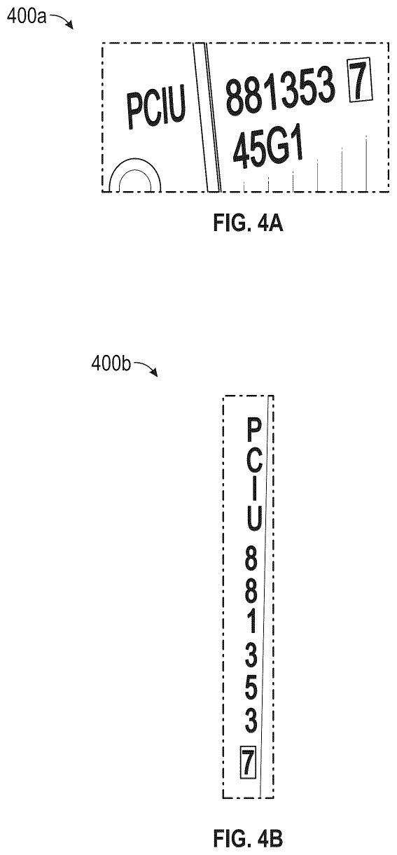

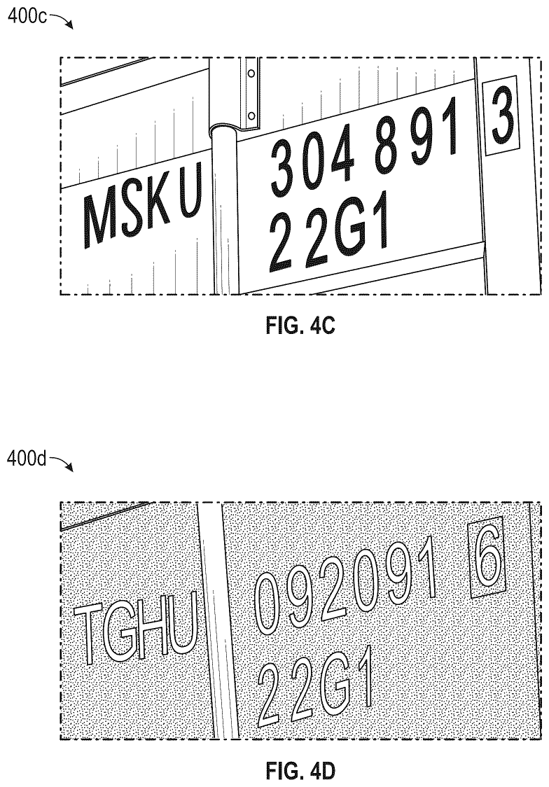

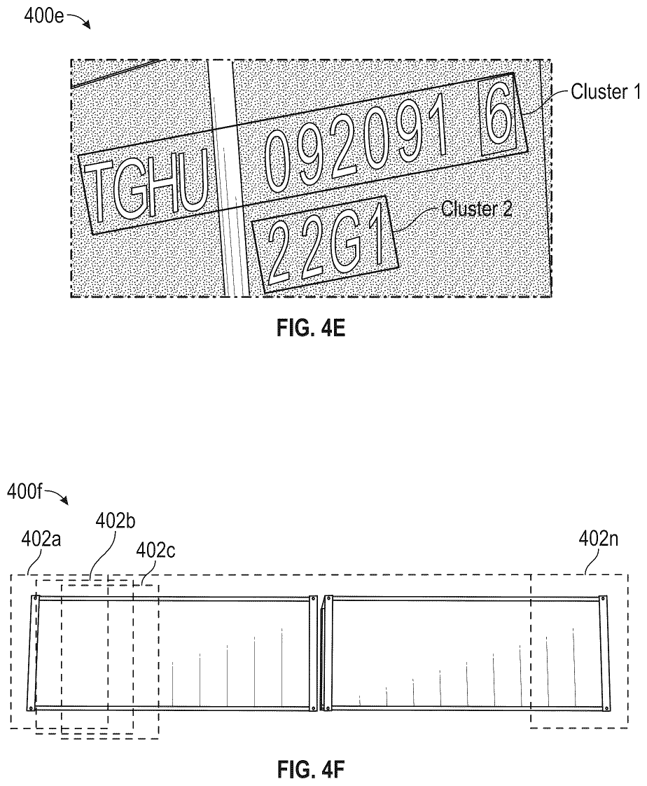

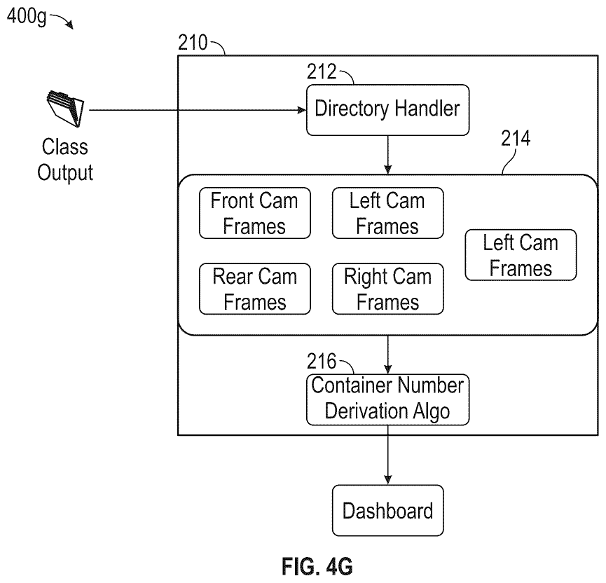

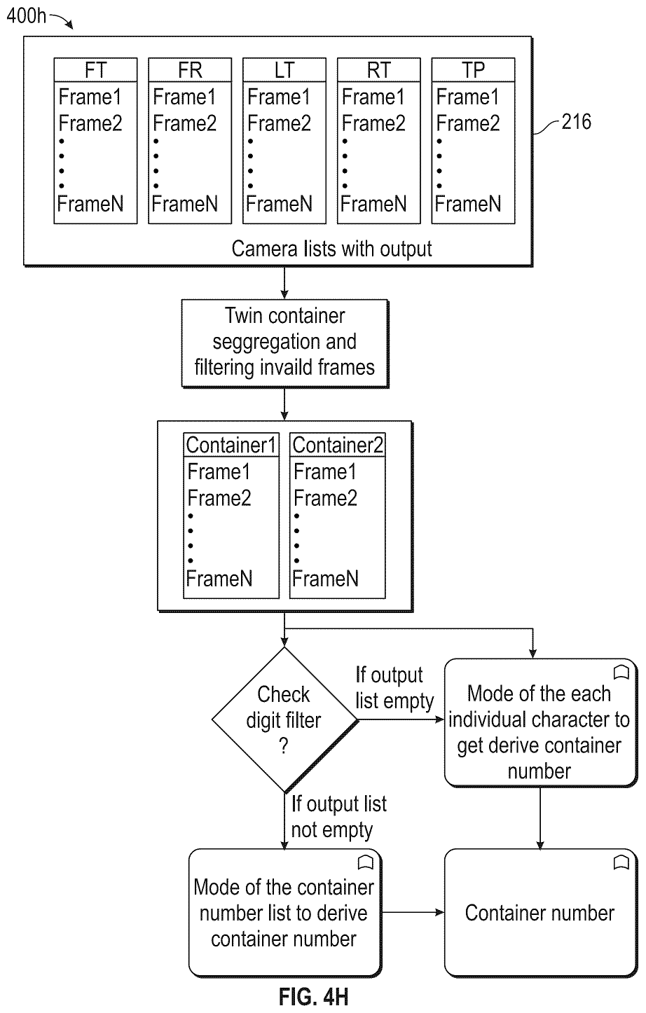

Referring to FIG. 4A, FIG. 4B are example diagrams 400a and 400b depicting the horizontal arrangement and vertical arrangement of container number, in accordance with one or more exemplary embodiments. The diagram 400a depicts the horizontal arrangement of the container numbers. The diagram 400b depicts the vertical arrangement of the container numbers. The container numbers may be painted in two different orientations on multiple sides of the container. For example, in one orientation the characters may be written in a horizontal arrangement and in another orientation, the characters may be written in a vertical arrangement. The container number detection module 110 may be configured to process the horizontal arrangement images and the vertical arrangement images of the container numbers. The segmentation and character classification module 208 may be configured to identify the arrangement of the container numbers using the aspect ratio of the container number images and further process them accordingly without any human intervention.

Referring to FIG. 4C, FIG. 4D are example diagrams 400c and 400d depicting dark characters against a light background and light characters against a dark background, in accordance with one or more exemplary embodiments. The diagram 400c depicts dark characters on the container against the light background. The diagram 400d depicts light characters on the container against the dark background. The segmentation algorithm works with any color of characters and background with contrast. The container numbers may be painted in different colors on the containers. The segmentation algorithm may be used to handle the container numbers painted in different colors without any human intervention.

The container numbers may be represented in different font colors depending on the color of the container. The thresholding technique may be used to convert the container number images to binary format. The computer vision techniques may be used to segment the characters. The statistical methods are used to perform the inversion without any human intervention.

Referring to FIG. 4E is an example diagram 400e depicting the container number arranged in multiple rows, in accordance with one or more exemplary embodiments. The diagram 400e depicts the container number arranged in multiple rows. Generally, the characters of the container number are arranged in multiple rows within a confined location. The segmentation and character classification module 208 may be configured to predict the container number by arranging the characters in the order as the containers images are captured at multiple angles when the container passes while the arrangement is not strictly horizontal or vertical. The segmentation and character classification module 208 may use non-supervised learning algorithms belonging to the clustering category to find the characters along each line. The container number detection module 110 may use non-supervised learning algorithms belonging to the clustering category to find the characters along each line.

Referring to FIG. 4F is an example diagram 400f depicting the container separation logic when the same truck carries two containers, in accordance with one or more exemplary embodiments. The diagram 400f depicts container frames 402a, 402b, 402c . . . , and 402n. The segmentation and character classification module 208 may be configured to discard unwanted characters using attributes for example width, height, mean, variance and so forth. There are instances where the segmentation algorithm generates non-character images as characters. The segmentation and character classification module 208 may be configured to discard many of such segments using image properties. The image properties may include, width, height, mean of pixels, variance of pixels and so forth.

In an exemplary embodiment, whenever a single truck carries multiple containers, it is required to output container numbers for all such instances. Generally, the truck carries up to a maximum number of two containers. As the truck passes through the gate infrastructure, the images of the containers may be captured using the side cameras (for example, the third camera or the fourth camera). The relative position of the container number on the container allows using the order of container numbers detection to separate the container frames 402a, 402b, 402c . . . , and 402n corresponding to each container.

As shown in FIG. 4F, the container frames 402a, 402b, 402c . . . , and 402n are captured continuously using the side cameras (for example, the third camera or the fourth camera) as the truck moves across the gate infrastructure. In the case of two containers, the container number may be detected in the container image frames at the end as well as at the center. Otherwise, the container number may be detected in the container image frames at the end. Hence, it is possible to differentiate between the two containers using the frame numbers of the container frames 402a, 402b, 402c . . . , and 402n collected from the same camera (For example, the third camera or the fourth camera) on which the container numbers are detected.

Referring to FIG. 4G is an example diagram 400g depicting the post-processing module, in accordance with one or more exemplary embodiments. The diagram 400g depicts a class output directory 402, and the post-processing module 210. The post-processing module 210 includes the directory handler module 212, the frame segregation module 214, and the container number generation module 216. The directory handler module 212 may be configured to read the image files placed in the class output directory and creates a truck instance per sequence_id. The truck instance may hold the list of output data. The output list may include the container frames of each side of the container, so in total it holds five lists (Front Cam, Rear Cam, Left Cam, Right Cam, and Top Cam).

The frame segregation module 214 may be configured to segregate the list based on the camera_id represented in the file name. All the class output data containing the same camera_id may be added to the corresponding list. A timer may be implemented per truck instance to trigger the process of generating container numbers from the above captured lists. The directory watcher watches the directories of the pipeline and may reset the timer of the truck instance when a new file with the same sequence_id is added to any of the directories in the pipeline. When no new file is added with the sequence_id for a specified period, then the timer thread may trigger the process of generating the container number from the output lists (Front, Rear, Left, Right, and Top).

In an exemplary embodiment, the trucks carrying two containers, the left camera, the right camera, and the top camera lists may hold the container number data, which belongs to both the containers. The output list may be sorted by frame_id and further split into two lists such that each list may hold the data belonging to a single container. The output list splitting may be performed by thresholding the frame_id which is part of the file name. Once segregation is performed, the lists (FT, BK, LT, RT, TP) belonging to a single container may be merged into a single list.

In the first level of filtering, each element in the container data list is a json data with the container number in it. Because not all container frames output may generate the container number with 11 characters, list elements with container numbers of less than 11 characters may be filtered out of the lists.

The 11th character in the container number is a check digit. At this stage, the list element which does not have a valid check digit may be removed from the list by the check digit filter. The container number with more occurrences (mode) in the list is the derived container number. After performing the check digit filter, if the length of the output list is empty (not a single item has a valid check digit), output from the first level filter is used to derive the container number by performing mode operation for individual characters.

Referring to FIG. 4H is an example diagram 400h depicting the container number generation module 416, in accordance with one or more exemplary embodiments. The diagram 400h includes the container number generation module 216 may be configured to obtain the camera lists with class output data. The container number generation module 216 may be configured segregate twin containers and filter invalid image frames. The container number generation module 216 may be configured to obtain two lists after the twin container segregation. The container number generation module 216 may be configured to perform list segregation, list merging, and filtering the invalid frames. The container number generation module 216 may be configured to filter the container number to less than 11 characters. The container number generation module 216 may be configured to apply a check digit filter to determine whether the output list is empty or not. If the output list is empty, the output from the first level filter may be used to derive the container number by performing mode operation for individual characters. If the output list is not empty, the mode of the container number list to derive the container number.

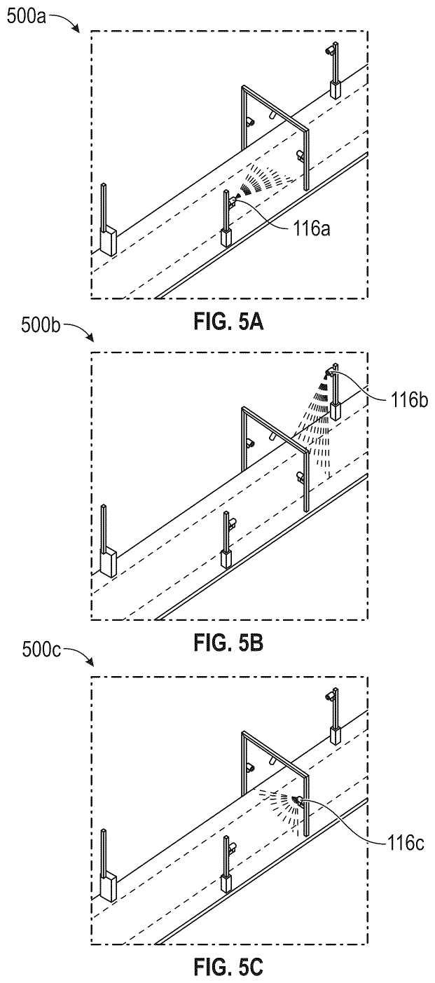

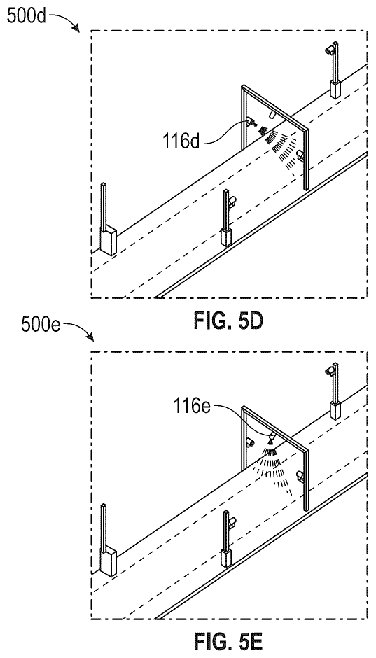

Referring to FIG. 5A is an example diagram 500a depicting the first camera view, in accordance with one or more exemplary embodiments. The diagram 500a includes the first camera 116a. The first camera 116a may be configured to capture a front view image data of the container to identify the container number located on the front side of the container.

Referring to FIG. 5B is an example diagram 500b depicting the second camera view, in accordance with one or more exemplary embodiments. The diagram 500b includes the second camera 116b. The second camera 116b may be configured to capture a rear view image data of the container to identify the container number located on the backside of the container.

Referring to FIG. 5C is an example diagram 500c depicting the third camera view, in accordance with one or more exemplary embodiments. The diagram 500c includes the third camera 116c. The third camera 116c may be configured to capture a right view image data of the container to identify the container number located on the right side of the container.

Referring to FIG. 5D is an example diagram 500d depicting the fourth camera view, in accordance with one or more exemplary embodiments. The diagram 500d includes the fourth camera 116d. The fourth camera 116d may be configured to capture a left view image data of the container to identify the container number located on the left side of the container.

Referring to FIG. 5E is an example diagram 500e depicting the fifth camera view, in accordance with one or more exemplary embodiments. The diagram 500e includes the fifth camera 116d. The fifth camera 116d may be configured to capture a top view image data of the container to identify the container number located on the top side of the container.

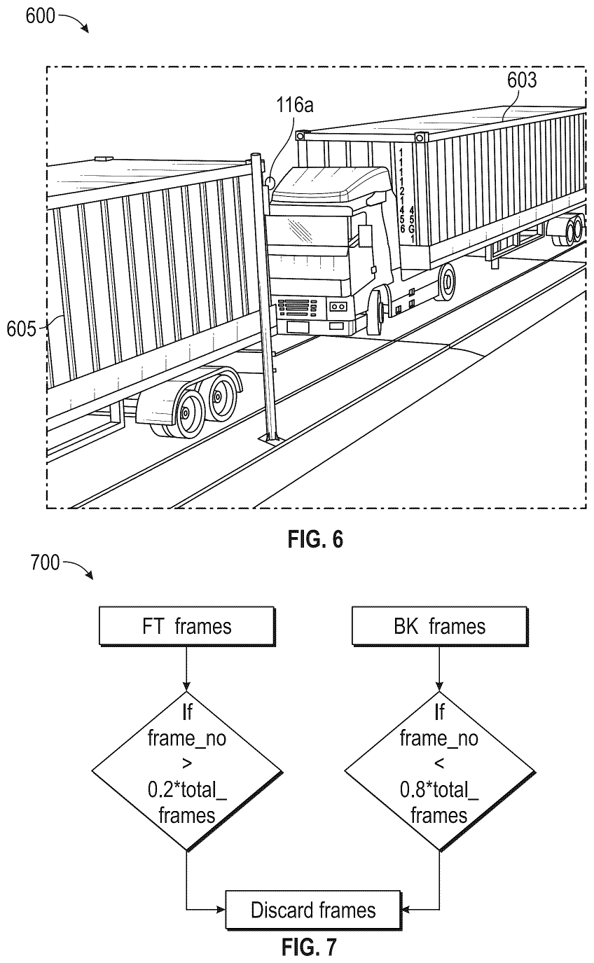

Referring to FIG. 6 is an example diagram 600 depicting the container-carrying trucks passing the gate infrastructure in close proximity, in accordance with one or more exemplary embodiments. The diagram 600 depicts the container-carrying trucks passing the gate infrastructure in a close proximity. The diagram 600 includes a first container 603 and a second container 605. The second container 605 is visible in the first camera 116a even before detecting the end of the first container 603. The container number detection module 110 may be configured to discard the detections based on the fact that these detections occur towards the end of the first container 603 transaction, and hence it is not possible for the first camera 116a to detect the container number corresponding to the first container 603 itself. A similar approach is followed using the second camera 116b to discard detections from the previous truck, using the fact that the second camera 116b may able to detect the container number of the first container 603 only towards the end of the transaction. The second camera 116b may detect the container number towards the end of motion detection, whereas the first camera 116a may detect the container number towards the start of the motion detection transaction.

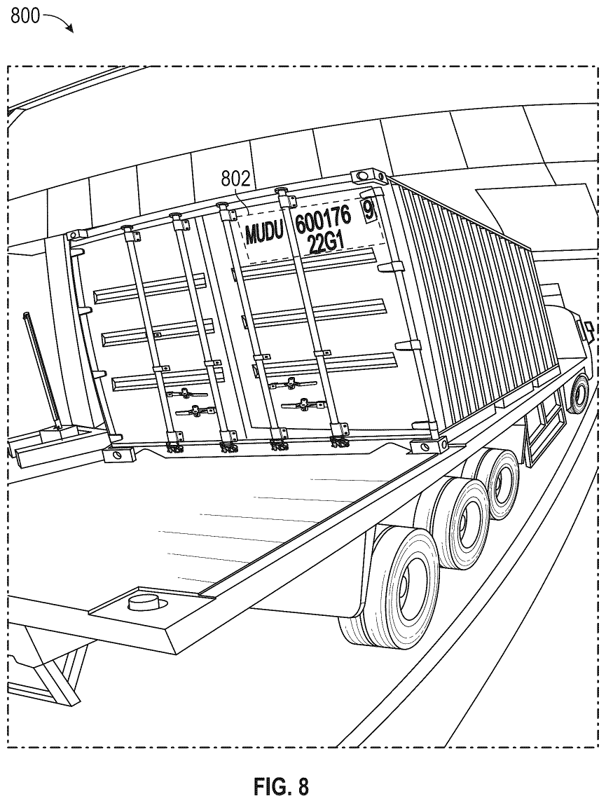

Referring to FIG. 7, FIG. 7 is example of flow diagram 700 depicting a method for discarding the detections, in accordance with one or more exemplary embodiments. The method 700 may be carried out in the context of the details of FIG. 1, FIG. 2, FIG. 3A, FIG. 3B, FIG. 3C, FIG. 3D, FIG. 3E, FIG. 3F, FIG. 4A, FIG. 4B, FIG. 4C, FIG. 4D, FIG. 4E, FIG. 4F, FIG. 4G, FIG. 4H, FIG. 5A, FIG. 5B, FIG. 5C, FIG. 5D, FIG. 5E, FIG. 6. However, the method 700 may also be carried out in any desired environment. Further, the aforementioned definitions may equally apply to the description below.

The method commence at step, capturing the front camera frame by the front camera 116a. Determining whether the front camera frame no>0.2*total_frames?. The method continues at step, discarding the frames. Further, the method continues at step, capturing the rear camera frame by the rear camera 116b. Determining whether the rear camera frame no<0.8*total_frames?. The method continues at step, discarding the frames. Any detections from the discarded frames above may belong to the containers either in front or behind the container of interest.

Referring to FIG. 8 is an example diagram 800 depicting the visual object detection, in accordance with one or more exemplary embodiments. The diagram 800 includes a container number region 802. The container number region 802 may be captured by the rear camera 116b.

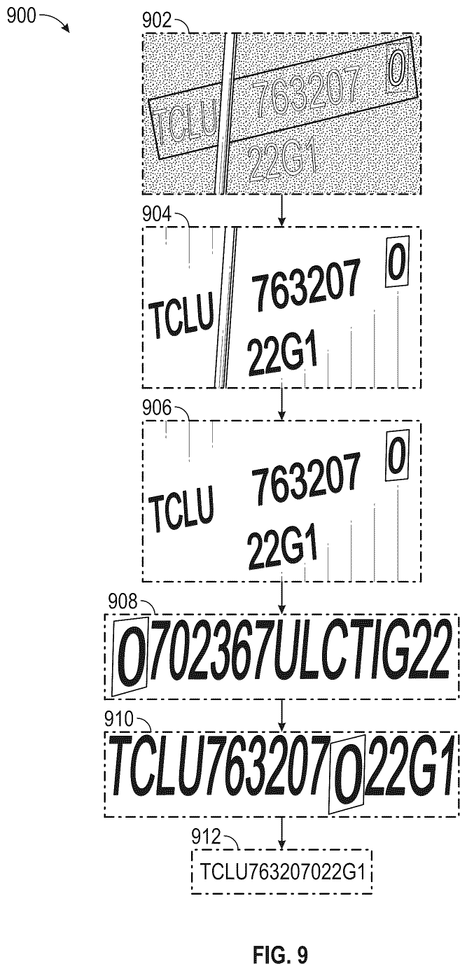

Referring to FIG. 9, FIG. 9 is an example of flow diagram 900 depicting a method of segmentation, in accordance with one or more exemplary embodiments. The method 900 may be carried out in the context of the details of FIG. 1, FIG. 2, FIG. 3A, FIG. 3B, FIG. 3C, FIG. 3D, FIG. 3E, FIG. 3F, FIG. 4A, FIG. 4B, FIG. 4C, FIG. 4D, FIG. 4E, FIG. 4F, FIG. 4G, FIG. 4H, FIG. 5A, FIG. 5B, FIG. 5C, FIG. 5D, FIG. 5E, FIG. 6, FIG. 7, FIG. 8. However, the method 900 may also be carried out in any desired environment. Further, the aforementioned definitions may equally apply to the description below.

The method commence at step 902, capturing the raw image data by the motion detection unit. Thereafter at step 904, saving the image data by the pre-processing module to perform the pre-processing of the captured image data. Thereafter at step 906, thresholding the image data by the visual object detection module to convert images to binary format. Thereafter at step 908, segmenting each character in the image data by the segmentation and character classification module. Thereafter at step 910, arranging the characters in the order based on their relative positions by the segmentation and character classification module. Thereafter at step 912, identifying and displaying the container number on the computing device by the post-processing module.

In an embodiment of the present disclosure directed towards, the method for detecting and identifying container number in real-time. The method commence at step, monitoring the vehicle carrying the containers into or out of the container storage yard by the motion detection unit. Triggering the first camera, the second camera, the third camera, the fourth camera, the fifth camera, and the laser sensors to capture container views by the pre-processing module. Transmitting containers image data to the computing device by the pre-processing module. Detecting the container number region in container image frames by the visual object detection module. Cropping the container number region situated on the container image frames by the visual object detection module. Applying two-dimensional Fast Fourier Transform to the cropped container number region by the visual object detection module to reduce an impact of shadows on the container image frames. Segmenting each character situated in the container number region by the segmentation and character classification module. Classifying each character situated in the container number region by the segmentation and character classification module. Arranging the characters in the order based on the relative positions of the characters to obtain the container number by the segmentation and character classification module. Aggregating the container image frames and generating the container number by a post-processing module.

Referring to FIG. 10, FIG. 10 is a block diagram illustrating the details of digital processing system 1000 in which various aspects of the present disclosure are operative by execution of appropriate software instructions. Digital processing system 1000 may correspond to the computing device (or any other system in which the various features disclosed above can be implemented).

Digital processing system 1000 may contain one or more processors such as a central processing unit (CPU) 1010, random access memory (RAM) 1020, secondary memory 1030, graphics controller 1060, display unit 1070, network interface 1080, an input interface 1090. All the components except display unit 1070 may communicate with each other over communication path 1050, which may contain several buses as is well known in the relevant arts. The components of FIG. 10 are described below in further detail.

CPU 1010 may execute instructions stored in RAM 1020 to provide several features of the present disclosure. CPU 1010 may contain multiple processing units, with each processing unit potentially being designed for a specific task. Alternatively, CPU 1010 may contain only a single general-purpose processing unit.

RAM 1020 may receive instructions from secondary memory 1030 using communication path 1050. RAM 1020 is shown currently containing software instructions, such as those used in threads and stacks, constituting shared environment 1025 and/or user programs 1026. Shared environment 1025 includes operating systems, device drivers, virtual machines, etc., which provide a (common) run time environment for execution of user programs 1026.

Graphics controller 1060 generates display signals (e.g., in RGB format) to display unit 1070 based on data/instructions received from CPU 1010. Display unit 1070 contains a display screen to display the images defined by the display signals. Input interface 1090 may correspond to a keyboard and a pointing device (e.g., touch-pad, mouse) and may be used to provide inputs. Network interface 1080 provides connectivity to a network (e.g., using Internet Protocol), and may be used to communicate with other systems (such as those shown in FIG. 1, a network 104) connected to the network 104.

Secondary memory 1030 may contain hard drive 1035, flash memory 1036, and removable storage drive 1037. Secondary memory 1030 may store the data software instructions (e.g., for performing the actions noted above with respect to the Figures), which enable digital processing system 1000 to provide several features in accordance with the present disclosure.

Some or all of the data and instructions may be provided on the removable storage unit 1040, and the data and instructions may be read and provided by removable storage drive 1037 to CPU 1010. Floppy drive, magnetic tape drive, CD-ROM drive, DVD Drive, Flash memory, a removable memory chip (PCMCIA Card, EEPROM) are examples of such removable storage drive 1037.

The removable storage unit 1040 may be implemented using medium and storage format compatible with removable storage drive 1037 such that removable storage drive 1037 can read the data and instructions. Thus, removable storage unit 1040 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 1040 or hard disk installed in hard drive 1035. These computer program products are means for providing software to digital processing system 1000. CPU 1010 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1030. Volatile media includes dynamic memory, such as RAM 1020. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1050. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

1. A system for detecting and identifying container number in real-time, comprising:
a motion detection unit configured to monitor a vehicle carrying one or more containers into or out of a container storage yard, whereby the motion detection unit comprising a first camera, a second camera, a third camera, a fourth camera, a fifth camera, one or more laser sensors, the first camera, the second camera, the third camera, the fourth camera, the fifth camera, and the one or more laser sensors configured to capture one or more containers views;
a pre-processing module configured to trigger the first camera, the second camera, the third camera, the fourth camera, the fifth camera, and the one or more laser sensors to capture the one or more container views, the pre-processing module configured to transmit one or more containers image data to a computing device through a processing device, whereby the computing device comprising a container number detection module configured to analyze the containers image data to identify the container number and displays the container number on the computing device;
the container number detection module comprising a visual object detection module configured to detect a container number region in one or more container image frames, the one or more container image frames are identified by the visual object detection module based on a field of view and orientation of the first camera, the second camera, the third camera, the fourth camera, and the fifth camera;
the visual object detection module configured to crop the container number region situated on the one or more container image frames, the visual object detection module configured to apply two-dimensional Fast Fourier Transform to reduce an impact of shadows on one or more container image frames;
a segmentation and character classification module configured to acquire the container number region as an output from the visual object detection module, whereby the segmentation and character classification module configured to segment each character situated in the container number region using one or more computer vision techniques and classifies each character using a neural network technique, the segmentation and character classification module configured to arrange the characters in an order based on relative positions of the characters to obtain the container number;
a post-processing module configured to generate the container number by aggregating the output from series of the one or more container image frames captured by the motion detection unit.

2. The system as claimed in claim 1, wherein the one or more containers image data comprising one or more front view images, one or more rear view images, one or more right view images, one or more left view images, and one or more top view images of the one or more containers.

3. The system as claimed in claim 1, wherein the container number region in the one or more container image frames are located on the one or more front view images, the one or more rear view images, the one or more right view images, the one or more left view images, and the one or more top view images of the one or more containers.

4. The system as claimed in claim 1, wherein the visual object detection module comprising neural network techniques are configured to detect the container number region where the container number is visible in the one or more container image frames.

5. The system as claimed in claim 4, wherein the container number region is stored in a directory and is accessed by the segmentation and character classification module for processing.

6. The system as claimed in claim 4, wherein the visual object detection module is configured to use a two-dimensional Fast Fourier Transform and merge high and low-frequency components to reduce shadow effects on the one or more container image frames.

7. The system as claimed in claim 1, wherein the pre-processing module comprising a multi-scale structural similarity index technique is configured to enhance an accuracy of motion detection performance of the first camera, the second camera, the third camera, the fourth camera, and the fifth camera and discard one or more false positives and one or more false negatives.

8. The system as claimed in claim 1, wherein the first camera, the second camera, the third camera, the fourth camera, the fifth camera, and the one or more laser sensors are used together to improve the accuracy of motion detection.

9. The system as claimed in claim 1, wherein the pre-processing module is configured to discard possibility of detecting the container numbers from at least one of: previous containers; next containers in a queue when the vehicle passes in a close proximity.

10. The system as claimed in claim 1, wherein the pre-processing module is configured to enable the second camera 116b to detect the container number towards the end of motion detection and the first camera 116a (front camera) to detect the container number towards the start of the motion detection.

11. The system as claimed in claim 1, wherein the pre-processing module is configured to perform concurrent and parallel processing to read the one or more containers image data from the motion detection unit 102 covering one or more container views and feed the one or more containers image data to the computing device 106 over the network 104.

12. The system as claimed in claim 1, wherein the segmentation and character classification module comprising a character segmentation technique is configured to process horizontal and vertical rows of characters situated in the one or more containers image data.

13. The system as claimed in claim 12, wherein the character segmentation technique is configured to process characters of different colors against various background colors.

14. The system as claimed in claim 1, wherein the segmentation and character classification module is configured to discard unwanted segments using one or more container images segment properties.

15. The system as claimed in claim 1, wherein the segmentation and character classification module comprising one or more clustering techniques are configured to group characters and to arrange the characters in the order.

16. The system as claimed in claim 1, wherein the post-processing module comprising a directory handler module is configured to read the one or more containers image data stored in a class output directory and creates a vehicle instance per sequence id.

17. The system as claimed in claim 1, wherein the post-processing module comprising a frame segregation module configured to segregate the one or more cameras list based on the camera_id represented in a file name.

18. The system as claimed in claim 1, wherein the first camera, the second camera, the third camera, the fourth camera, and the fifth camera are configured to operate in an infrared mode to capture one or more infrared mode container images to obtain better results during low light conditions.

19. The system as claimed in claim 1, wherein the container number detection module configured to use real-time information and detection results from at least one of: the first camera, the second camera, the third camera, the fourth camera, and the fifth camera to separate the one or more container image frames belonging to one or more containers stacked on the same vehicle.

20. The system as claimed in claim 1, wherein the container number generation module is configured segregate twin containers and filter invalid container image frames.

21. The system as claimed in claim 1, wherein the container number generation module is configured to obtain two lists after the twin container segregation.

22. The system as claimed in claim 1, wherein the container number generation module is configured to perform list segregation, list merging, and filtering the one or more invalid container image frames.

23. The system as claimed in claim 1, wherein the container number generation module is configured to filter the container number less than eleven characters.

24. The system as claimed in claim 1, wherein the container number generation module is configured to apply a check digit filter to determine whether the output list is empty or not.

25. A method for detecting and identifying container number in real-time, comprising:
monitoring a vehicle carrying one or more containers into or out of a container storage yard by a motion detection unit, the motion detection unit comprising a first camera, a second camera, a third camera, a fourth camera, a fifth camera, one or more laser sensors;
triggering the first camera, the second camera, the third camera, the fourth camera, the fifth camera, and the one or more laser sensors to capture one or more container views by the pre-processing module;
transmitting one or more containers image data to a computing device by the pre-processing module;
detecting a container number region in one or more container image frames by a visual object detection module;
cropping the container number region situated on the one or more container image frames by the visual object detection module;
applying a two-dimensional Fast Fourier Transform to the cropped container number region by the visual object detection module to reduce an impact of shadows on one or more container image frames;
segmenting each character situated in the container number region by the segmentation and character classification module;
classifying each character situated in the container number region by the segmentation and character classification module;
arranging the characters in an order based on relative positions of the characters to obtain the container number by the segmentation and character classification module; and
aggregating the one or more container image frames and generating the container number by a post-processing module.
